(19) United States
(12) Patent Application Publication
(10) Pub. No.: US 2006/0067026 A1
(43) Pub. Date: Mar. 30, 2006

(54) Stun gun

(76) Inventor: Dennis R. Kaufman, Willoughby, OH (US)

Correspondence Address: Jeffrey Schox, Esq.;Schox, PLC, Suite 2A, 209 S. Fourth Avenue, Ann Arbor, MI, 48104, US

(21) Appl. No.: 10/957,301

(22) Filed: Sep. 30, 2004

(51) Int. Cl. H01H 1/00

(52) U.S. Cl. 361/232

(57) ABSTRACT

The stun gun of one embodiment includes: a first dart coupled to a tether and positioned to be propelled along a first trajectory, a second dart coupled to a tether and positioned to be propelled along a second trajectory divergent to the first trajectory, and a third dart coupled to a tether and positioned to be propelled along a third trajectory substantially parallel to the first trajectory. The stun gun also includes a power source having opposing charges and an activation circuit. The activation circuit is adapted to selectively connect one of the opposing charges to the first dart and connect the other of the opposing charges to the second and third darts.

### TECHNICAL FIELD

This invention relates generally to the stun gun field, and more specifically to an improved taser.

### BACKGROUND

Stun guns are less-than-lethal weapons used by army personnel, police officers, and individuals as protection against terrorist, criminal, and personal attacks. Stun guns work by applying a high-voltage, but low-current, electrical charge. Since the nervous system in the human body works by sending electrical charges through neural pathways, the electrical charge provided by a stun gun “confuses” the nervous system. This confusion can cause recipients of an electrical charge from a stun gun to feel paralyzed for a brief instant, or can cause a spasm or convulsion in an area of their body.

The most common type of stun gun requires the user of the device to place metal electrodes directly in contact with the recipient. A longer-range version is the taser (named after Thomas A Swift's Electronic Rifle in the Tom Swift series created by Victor Appleton). In a taser stun gun, small darts with long wires are connected to the electrodes and are propelled toward the recipient by a propellant.

To effectively stun a recipient, two darts (with opposite charges) must connect with the recipient at a sufficient distance (approximately 20 cm or 0.5 feet). Because the height of most stun guns is less than this distance, the two darts must be propelled at an angle to each other. Typical taser stun guns are designed to propel a first dart along a first horizontal trajectory and to propel a second dart along a second divergent trajectory (typically 7° below horizontal). These typical taser stun guns provide a range of approximately 2-6 meters or 7-20 feet. At closer distances, the darts will not separate enough. At longer distances, the darts will separate too much and will not likely both embed in the recipient to complete the circuit.

Increasing the effective spread between the darts at close range causes a corresponding undesired increase in the effective spread of the darts at long range. Decreasing the effective spread between the darts at long range causes a corresponding undesired decrease in the effective spread of the darts at short range. Thus, long range effectiveness is sacrificed for close range effectiveness and vice versa.

There is a need in the stun gun field to create a taser with an improved effective range. This invention provides such improved taser.

### BRIEF DESCRIPTION OF THE FIGURES

FIG. 1 is a representation of the body and the projected trajectory of the four darts of the stun gun of the preferred embodiment.

FIG. 2 is a schematic of the components of the stun gun of the preferred embodiment.

FIG. 3 is a detailed view of the primary dart cartridge and the secondary dart cartridge of the stun gun of the preferred embodiment.

### DESCRIPTION OF THE PREFERRED EMBODIMENT

The following description of the preferred embodiment of the invention is not intended to limit the invention to this preferred embodiment, but rather to enable any person skilled in the art of stun guns to make and use this invention.

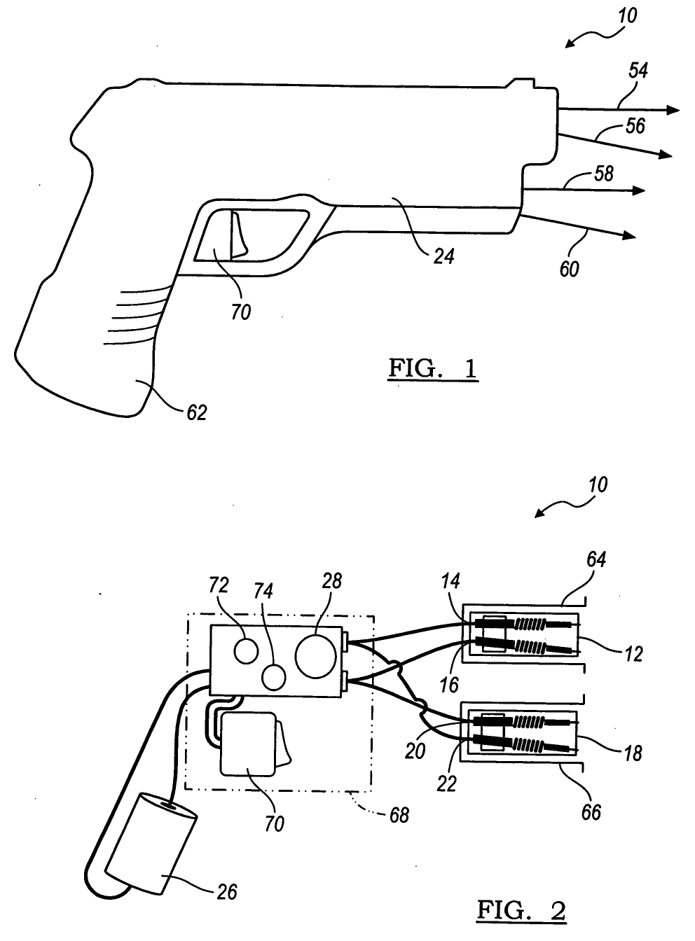

As shown in FIGS. 1 and 2, the stun gun 1o of the preferred embodiment includes: a primary dart cartridge 12 defining a first electrical connector 14 and a second electrical connector 16, a secondary dart cartridge 18 defining a third electrical connector 20 and a fourth electrical connector 22, a body 24, a power source 26 having opposing charges, and an activation circuit 28. The activation circuit 28 is coupled to the body 24 and adapted to selectively connect one of the opposing charges to the first electrical connector 14 and the fourth electrical connector 22 and connect the other of the opposing charges to the second electrical connector 16 and the third electrical connector 20.

The primary dart cartridge 12 and the secondary dart cartridge 18 are preferably identical and preferably replaceable, conventional dart cartridges. The primary dart cartridge 12 and the secondary dart cartridge 18 may, however, be different in any suitable manner and may be specially designed and manufactured for the stun gun 1o of the present invention.

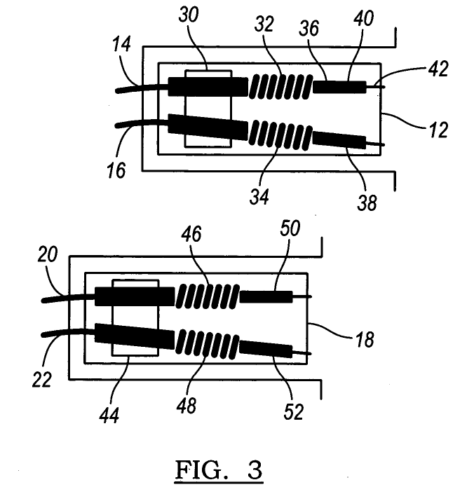

As shown in FIG. 3, the primary dart cartridge 12 preferably defines the first electrical connector 14 and the second electrical connector 16 and preferably substantially encloses a propellant 30, a first tether 32, a second tether 34, a first dart 36, and a second dart 38. The primary dart cartridge 12 may alternatively enclose other suitable devices, such as a pressurized tank of conductive fluid (e.g., salt water) and a nozzle.

The propellant 30 functions to propel the first dart 36 and second dart 38 toward the recipient. The propellant 30 is preferably divided into a first portion that propels the first dart 36 and a second portion that propels the second dart 38, but may alternatively be provided as a single unit that simultaneously propels the first dart 36 and the second dart 38. The propellant 30 is preferably a smokeless powder, which includes nitrocellulose flakes, but may alternatively be any suitable propellant including compressed gas.

The first tether 32 functions to electrically connect the first electrical connector 14 to the first dart 36, and the second tether 34 functions to electrically connect the second electrical connector 16 to the second dart 38. The first tether 32 and the second tether 34 are preferably made from a thin, insulated wire with a length of approximately 10 meters or 31 feet. The first tether 32 and the second tether 34 may alternatively be made from any suitable material with any suitable length.

The first dart 36 functions to attach to the recipient at a first location, while the second dart 38 functions to attach to the recipient at a second location. By using the conductive body of the recipient, the first dart 36 and the second dart 38 assist in the completion of an electrical circuit. The first dart 36 and the second dart 38 preferably include a shaft section 40 that assists during the flight and a point section 42 that assists in the attachment. The first dart 36 and the second dart 38 may, however, include any suitable device that assists during the flight and in the attachment. The first dart 36 and the second dart 38 are preferably made from a conductive metallic material, but may alternatively be made from any suitable material.

The secondary dart cartridge 18 preferably defines the third electrical connector 20 and the fourth electrical connector 22 and substantially encloses a propellant 44, a third tether 46, a fourth tether 48, a third dart 50, and a fourth dart 52. Physically, the secondary dart cartridge 18 is preferably identical to the primary dart cartridge 12.

As shown in FIGS. 1 and 2, the first dart 36 is preferably positioned to be propelled along a first trajectory 54 that is substantially horizontal to the sight of the stun gun lo. The second dart 38 is preferably positioned to be propelled along a second trajectory 56 that is divergent to the first trajectory 54. The angle of the divergence between the first trajectory 54 and the second trajectory 56 is preferably between 4° and 10°, more preferably between 6° and 8°, and most preferably 7°. The third dart 50 is preferably positioned to be propelled along a third trajectory 58 that is substantially parallel to the first trajectory 54. The fourth dart 52 is preferably positioned to be propelled along a fourth trajectory 60 that is divergent to the third trajectory 58. The angle of the divergence between the third trajectory 58 and the fourth trajectory 60 is preferably between 4° and 10°, more preferably between 6° and 8°, and most preferably 7°. With this particular arrangement, the combination of the four darts produces an effective spread of 25 inches at 15 feet, an effective spread of 35 inches at 21 feet, and an effective spread of 18-24 inches at 31 feet.

The body 24 functions to house the primary dart cartridge 12, the secondary dart cartridge 18, the power source 26, and the activation circuit 28. The body 24 preferably includes a conventional grip or handle 62, but may alternatively include other holding devices. To house the primary dart cartridge 12 and the secondary dart cartridge 18, the body 24 preferably includes a primary dart chamber 64 and a secondary dart chamber 66. The primary dart chamber 64 and the secondary dart chamber 66 are preferably arranged in a so-called under and over arrangement with the secondary dart chamber 66 located immediately below the primary dart chamber 64. The primary dart chamber 64 and the secondary dart chamber 66 may, however, be arranged in any suitable manner, such as in a side-by-side arrangement. The body 24 is preferably made from a durable, lightweight plastic, but may alternatively be made from any suitable material.

The power source 26 functions to provide the electrical charge to the recipient. Preferably, the power source 26 is a lithium battery, such as a DURACELL DL123. Alternatively, the power source 26 may be any suitable device that supplies an electrical charge. The power source 26, like all batteries, includes opposing charges, which are commonly referred to as positive charge and negative charge.

The activation circuit 28 functions to selectively connect one of the opposing charges to the first electrical connector 14 and the fourth electrical connector 22 and connect the other of the opposing charges to the second electrical connector 16 and the third electrical connector 20. This particular arrangement, which has been named the cross-wire arrangement, facilitates the use of standard dart cartridges and the improvement of the effective range.

In the preferred embodiment, the stun gun 10 also includes a control unit 68 that includes a trigger mechanism 70, a deployment circuit 72, the activation circuit 28, and a transformation circuit 74. The trigger mechanism 70 functions to receive an input from the user of the stun gun 10. The trigger mechanism 70 is preferably an electromechanical device, but may alternatively be any suitable device that receives an input. The deployment circuit 72 functions to ignite the propellant 30 after an input from the user has been received by the trigger mechanism 70. The deployment circuit 72 is preferably a conventional circuit, such as the ammunition detonating circuit described in U.S. Pat. No. 6,575,073 (which is hereby incorporated in its entirety by this reference). The deployment circuit 72 may alternatively be any suitable circuit that ignites the propellant 30. The transformation circuit 74 functions to transform the supplied electrical charge from the power source 26 into an appropriate electrical charge for the stun gun 10. An appropriate electrical charge preferably includes 50,000 volts at 4-6 milliamps, but may alternatively include other suitable electrical parameters.

In an alternative embodiment, the trigger mechanism 70 and the activation circuit 28 may be adapted to allow the selective propulsion of either two darts or four darts. By choosing the simultaneous deployment of all four darts, the user can quadruple their chances of connecting with the recipient. On the other hand, by choosing the sequential deployment of two darts and then two more darts, the user can double the number of available propulsions before reloading. This adaptation maybe implemented with an additional switch on the body 24 of the stun gun 10, may be implemented with two-stage trigger mechanism 70, or may be implemented with any other suitable device.

In a further alternative embodiment, the stun gun 10 may include a sight, which functions to assist in the aiming of the stun gun 10. Preferably the sight includes a conventional laser or a conventional blade, but may alternatively include other suitable devices to assist in the aiming of the stun gun 10.

As a person skilled in the art of stun guns will recognize from the previous detailed description and from the figures and claims, modifications and changes can be made to the preferred embodiments of the invention without departing from the scope of this invention defined in the following claims.

I claim:

1. A stun gun comprising:
a primary dart cartridge defining a first electrical connector and a second electrical connector and substantially enclosing a first tether coupled to the first electrical connector, a second tether coupled to the second electrical connector, a first dart coupled to the first tether and positioned to be propelled along a first trajectory, and a second dart coupled to the second tether and positioned to be propelled along a second trajectory divergent to the first trajectory;
a secondary dart cartridge defining a third electrical connector and a fourth electrical connector and substantially enclosing a third tether coupled to the third electrical connector, a fourth tether coupled to the fourth electrical connector, a third dart coupled to the third tether and positioned to be propelled along a third trajectory substantially parallel to the first trajectory, and a fourth dart coupled to the fourth tether and positioned to be propelled along a fourth trajectory divergent to the third trajectory;
a body defining a primary dart chamber adapted to engage the primary dart cartridge and a secondary dart chamber adapted to engage the secondary dart cartridge;
a power source having opposing charges; and
an activation circuit coupled to the body and adapted to selectively connect one of the opposing charges to the first electrical connector and the fourth connector and connect the other of the opposing charges to the second electrical connector and the third electrical connector.

2. The stun gun of claim 1 wherein the second trajectory is angled approximately 7° relative to the first trajectory.

3. The stun gun of claim 2 wherein the fourth trajectory is angled approximately 7° relative to the third trajectory.

4. The stun gun of claim 3 wherein the secondary dart chamber is located at a distance from the first dart chamber.

5. A stun gun for use with two dart cartridges, each dart cartridge having a first electrical connector and a second electrical connector and substantially enclosing a first tether coupled to the first electrical connector, a second tether coupled to the second electrical connector, a first dart coupled to the first tether and positioned to be propelled along a first trajectory, and a second dart coupled to the second tether and positioned to be propelled along a second trajectory divergent to the first trajectory, the stun gun comprising:
a body defining a primary dart chamber adapted to engage a first of the two dart cartridges and a secondary dart chamber adapted to engage a second of the two dart cartridges;
a power source having opposing charges; and
an activation circuit coupled to the body and adapted to selectively connect one of the opposing charges to the first electrical connector of the first dart cartridge and the second electrical connector of the second dart cartridge and connect the other of the opposing charges to the second electrical connector of the first dart cartridge and the first electrical connector of the second dart cartridge.

6. The stun gun of claim 5 wherein the secondary dart chamber is located at a distance from the first dart chamber.

7. A stun gun comprising:
a first electrical connector, a first tether coupled to the first electrical connector, and a first dart coupled to the first tether and positioned to be propelled along a first trajectory;
a second electrical connector, a second tether coupled to the second electrical connector, and a second dart coupled to the second tether and positioned to be propelled along a second trajectory divergent to the first trajectory;
a third electrical connector, a third tether coupled to the third electrical connector, and a third dart coupled to the third tether and positioned to be propelled along a third trajectory substantially parallel to the first trajectory;
a power source having opposing charges; and
an activation circuit adapted to selectively connect one of the opposing charges to the first electrical connector and connect the other of the opposing charges to the second electrical connector and the third electrical connector.

8. The stun gun of claim 7 further comprising:
a fourth electrical connector, a fourth tether coupled to the fourth electrical connector, and a fourth dart coupled to the fourth tether and positioned to be propelled along a fourth trajectory divergent to the first trajectory.

9. The stun gun of claim 8 wherein the activation circuit is further adapted to selectively connect one of the opposing charges to the first electrical connector and the fourth connector and connect the other of the opposing charges to the second electrical connector and the third electrical connector.

10. The stun gun of claim 9 further comprising a body coupled to the activation circuit.

11. The stun gun of Claim lo further comprising a primary dart cartridge defining the first electrical connector and the second electrical connector and substantially enclosing the first tether, the second tether, the first dart, and the second dart.

12. The stun gun of claim 11 wherein the body defines a primary dart chamber adapted to engage the primary dart cartridge.

13. The stun gun of claim 12 further comprising a secondary dart cartridge defining the third electrical connector and the fourth electrical connector and substantially enclosing the third tether, the fourth tether, the third dart, and the fourth dart.

14. The stun gun of claim 13 wherein the body further defines a secondary dart chamber adapted to engage the secondary dart cartridge.

15. The stun gun of claim 14 wherein the secondary dart chamber is located at a distance from the first dart chamber.
